(19) United States
(12) Patent Application Publication
(10) Pub. No.: US 2007/0077433 A1
(43) Pub. Date: Apr. 5, 2007

(54) Carbon nanotube structure and method of shaping the same

(76) Inventors: Tae-Won Jeong, Seoul (KR); Jeong-Na Heo, Yongin-si (KR); Jeong-Hee Lee, Seongnam-si (KR); Shang-Hyeun Park, Boryeong-si (KR)

Correspondence Address: Robert E. Bushnell;Suite 300, 1522 K Street, N.W., Washington, DC, 20005, US

(21) Appl. No.: 11/434,268

(22) Filed: May 16, 2006

(30) Foreign Application Priority Data
May 24, 2005 (KR) 10-2005-0043748

(51) Int. Cl. B32B 9/00; B29C 59/02

(52) U.S. Cl. 428/408; 264/320; 427/355; 427/248.1; 204/192.1

(57) ABSTRACT

A carbon nanotube structure and a method of shaping the carbon nanotube structure are provided. The carbon nanotube structure includes a substrate, carbon nanotubes formed on the substrate and shaped in a predetermined shape, and a metal layer formed on the surfaces of the carbon nanotubes to maintain the carbon nanotubes in the predetermined shape. The carbon nanotube structure has high purity and improved conductivity.

### CROSS-REFERENCE TO RELATED PATENT APPLICATION AND CLAIM OF PRIORITY

This application claims the benefit of Korean Patent Application No. 10-2005-0043748, filed on May 24, 2005, in the Korean Intellectual Property Office, the disclosure of which is incorporated herein in its entirety by reference.

### BACKGROUND OF THE INVENTION

1. Field of the Invention

The present invention relates to a carbon nanotube structure and a method of shaping the same.

2. Description of the Related Art

Since the unique structural and electrical characteristics of carbon nanotubes (CNTs) were found, carbon nanotubes have been applied to various devices, such as field emission devices (FEDs), back lights for liquid crystal displays (LCDs), nano electronic devices, actuators, and batteries.

Methods of forming carbon nanotubes include screen printing using a paste and chemical vapor deposition (CVD). The CVD method includes plasma enhanced chemical vapor deposition (PECVD) and thermal chemical vapor deposition (thermal CVD).

A plurality of carbon nanotubes formed by these methods form a carbon nanotube structure on a substrate, and the surface of the carbon nanotube structure is further treated or, if necessary, the carbon nanotube structure is formed into a predetermined shape in addition to the surface treatment. For this purpose, chemical mechanical polishing (CMP), which is a combination of mechanical and chemical removing processes, or etching can be used.

However, the CMP method is expensive and can damage the carbon nanotube structure, and the etching method can deform the carbon nanotube structure. Also, both methods are complicated, and may reduce the purity of the carbon nanotube by introducing impurities.

### SUMMARY OF THE INVENTION

The present invention provides a carbon nanotube structure formed by a simple process and having high purity and improved conductivity, and a method of shaping the carbon nanotube structure.

According to an aspect of the present invention, there is provided a carbon nanotube structure comprising: a substrate; carbon nanotubes formed on the substrate and shaped in a predetermined shape; and a metal layer formed on surfaces of the carbon nanotubes to maintain the carbon nanotubes in the predetermined shape.

According to another aspect of the present invention, there is provided a method of forming a carbon nanotube structure, the method comprising: growing carbon nanotubes on a substrate; forming a metal layer on surfaces of the carbon nanotubes; locating a hot pressing apparatus having a mold including a predetermined pattern above upper surfaces of the carbon nanotubes on which the metal layer is formed; and inserting the carbon nanotubes on which the metal layer is formed into the mold of the hot pressing apparatus, and heating and pressing the carbon nanotubes using the hot pressing apparatus.

The hot pressing apparatus may heat the carbon nanotubes to above the melting point of the metal that constitutes the metal layer.

The metal layer may be formed of metal selected from the group consisting of Au, Ag, indium (In), and an alloy of Au—Sn.

The metal layer may be formed by depositing a metal on the surfaces of the carbon nanotubes by sputtering or electron beam evaporation.

According to yet another aspect of the present invention, there is provided a method of shaping a carbon nanotube structure, including: preparing carbon nanotubes on a substrate; forming a metal layer on surfaces of the carbon nanotubes; and shaping the carbon nanotubes by changing a shape of the metal layer formed on the carbon nanotubes into a predetermined shape.

### BRIEF DESCRIPTION OF THE DRAWINGS

A more complete appreciation of the present invention, and many of the above and other features and advantages of the present invention, will become more be readily apparent as the same becomes better understood by describing in detail exemplary embodiments thereof with reference to the attached following detailed description when considered in conjunction with the accompanying drawings in which: like reference symbols indicate the same or similar components, wherein:

FIG. 1 is a cross-sectional view of a carbon nanotube structure according to an embodiment of the present invention;

FIGS. 2A through 2E are cross-sectional views for explaining a method of shaping the carbon nanotube structure of FIG. 1; and

FIGS. 3A and 3B are scanning electron microscope (SEM) images of carbon nanotube structures before and after shaping.

### DETAILED DESCRIPTION OF THE INVENTION

The present invention will now be described more fully with reference to the accompanying drawings, in which exemplary embodiments of the invention are shown. In the drawings, the thicknesses of layers and regions are exaggerated for clarity. Like reference numerals refer to like elements throughout the drawings.

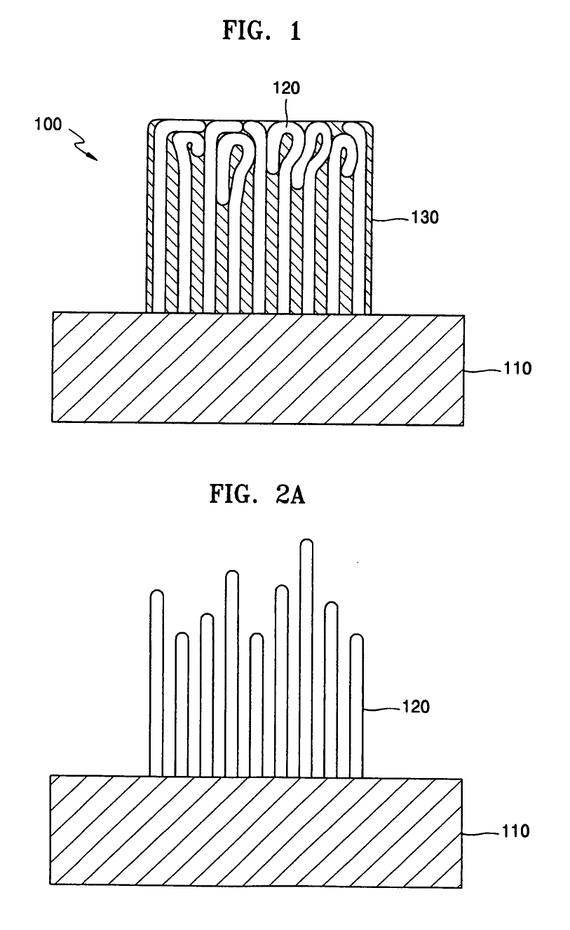

FIG. 1 is a cross-sectional view of a carbon nanotube (CNT) structure according to an embodiment of the present invention.

Referring to FIG. 1, a carbon nanotube structure 100 includes a substrate 110, a plurality of carbon nanotubes (CNTs) 120 grown on the substrate 110, and a metal layer 130 formed on the surfaces of the carbon nanotubes 120.

The carbon nanotubes 120 are formed in a predetermined shape. The metal layer 130 formed on the surfaces of the carbon nanotubes 120 maintains the shape of the carbon nanotubes 120. That is, the carbon nanotubes 120 tend to return to their original shape after being deformed, due to their flexibility. Therefore, the metal layer 130 maintains the deformed shape of the carbon nanotubes 120. Also, the metal layer 130 can improve the conductivity of the carbon nanotube structure 100. The metal layer 130 can be formed of metal selected from the group consisting of Au, Ag, indium (In), and an alloy of Au—Sn.

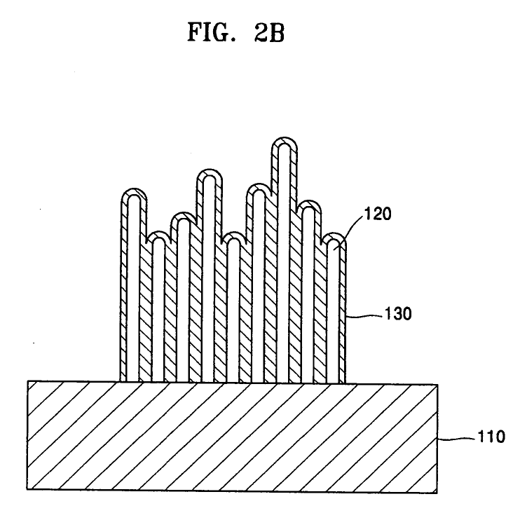

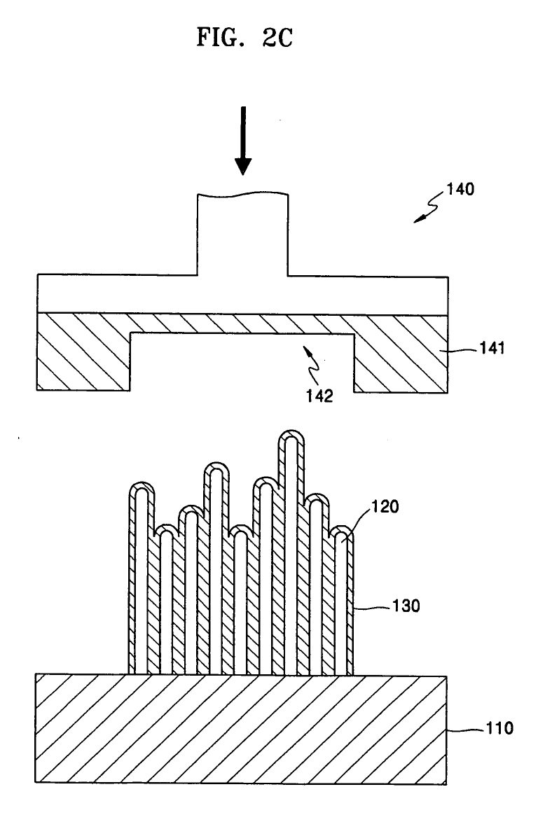

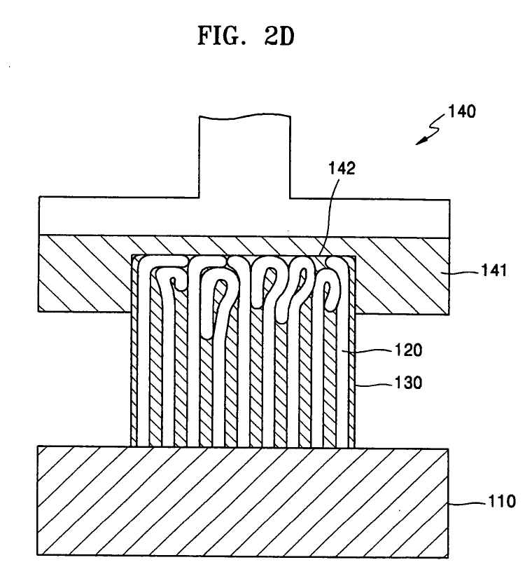

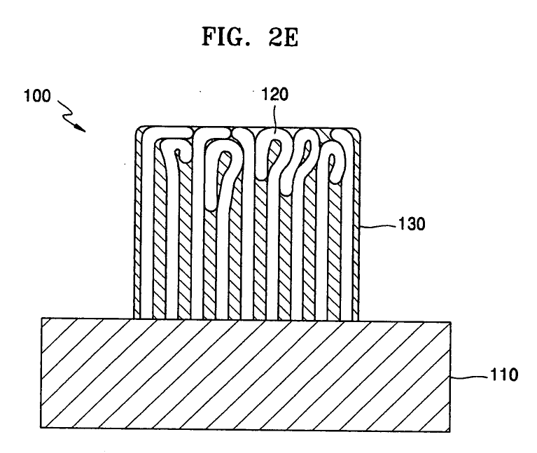

A method of shaping the carbon nanotube structure 100 will now be described. FIGS. 2A through 2E are cross-sectional views for explaining a method of shaping the carbon nanotube structure of FIG. 1.

Referring to FIG. 2A, a plurality of carbon nanotubes 120 are grown on the substrate 110. The carbon nanotubes 120 can be grown, for example, by chemical vapor deposition (CVD). Here, the CVD method can be thermal CVD or plasma enhanced chemical vapor deposition (PECVD). The thermal CVD method can grow carbon nanotubes with high uniformity and smaller diameter than those grown by the PECVD method. Therefore, the carbon nanotubes grown by thermal CVD have a low turn on voltage for electron emission. On the other hand, the PECVD method can grow carbon nanotubes in a perpendicular direction to the substrate 110 and can synthesize carbon nanotubes at a lower temperature than the thermal CVD method. The carbon nanotubes 120 can also be grown by various other methods as well as those described above.

Referring to FIG. 2B, a metal layer 130 is formed to cover the entire surfaces of the carbon nanotubes 120 grown on the substrate 110. Here, the metal layer 130 can be formed by depositing metal by sputtering, or by electron beam evaporation. The metal layer 130 can be formed of metal selected from the group consisting of Au, Ag, indium (In), and an alloy of Au—Sn.

Referring to FIG. 2C, a hot pressing apparatus 140 is located above the carbon nanotubes 120 on which the metal layer 130 is formed. The hot pressing apparatus 140 includes a mold 141 having a predetermined pattern 142. The pattern 142 of the mold 141 can be formed in a shape corresponding to the desired final shape of the carbon nanotubes 120. The mold 141 is located to face the upper surfaces of the carbon nanotubes 120. The pattern 142 of the mold 141 can be a concave groove, but the present invention is not limited thereto. The pattern 142 of the mold 141 can be formed in various shapes corresponding to the desired final shape of the carbon nanotubes 120.

Referring to FIG. 2D, the upper part of the carbon nanotubes 120 is inserted into the pattern 142 of the mold 141 of the hot pressing apparatus 140 by moving the hot pressing apparatus 140 toward the carbon nanotubes 120. The hot pressing apparatus 140 simultaneously applies heat and pressure to the carbon nanotubes 120 on which the metal layer 130 is formed so that the upper surface of the carbon nanotubes 120 is formed into a shape corresponding to the pattern 142 of the mold 141. At this time, the hot pressing apparatus 140 heats the carbon nanotubes 120 to above the melting point of the metal of the metal layer 130, so that the shape of the carbon nanotubes 120 can be readily controlled. After the shape of the carbon nanotubes 120 has changed as desired, the melted metal is solidified by cooling the metal. Afterward, the hot pressing apparatus 140 is lifted from the upper surfaces of the carbon nanotubes 120. Then, the solidified metal layer 130 between the carbon nanotubes 120 maintains the deformed shape of the carbon nanotubes 120. As a result, as depicted in FIG. 2E, the carbon nanotube structure 100 formed in a predetermined shape is obtained.

According to the present invention, the carbon nanotube structure 100 can be shaped by a simple process, and has a high purity since it is formed of only the carbon nanotubes 120 and the metal layer 130, without any impurity. The metal layer 130 included in the carbon nanotube structure 100 can improve the conductivity of the carbon nanotube structure 100.

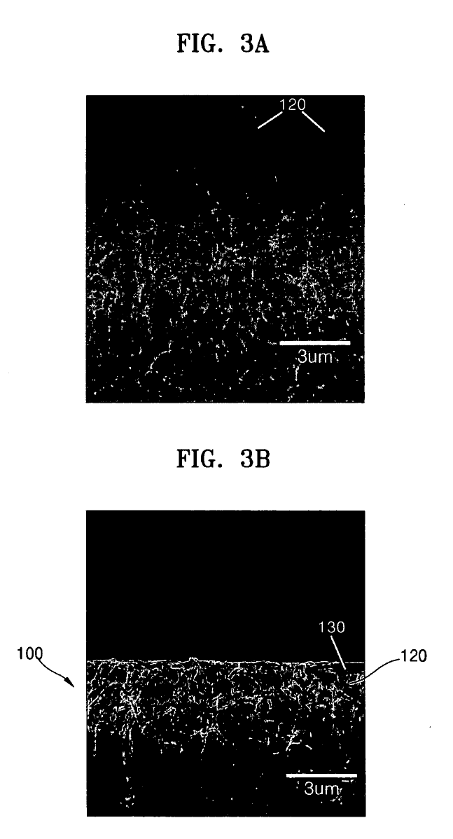

FIGS. 3A and 3B are scanning electron microscope (SEM) images of carbon nanotube structures before and after shaping.

Referring to FIG. 3A, the grown carbon nanotubes 120 do not have a uniform shape. As depicted in FIG. 3B, after the carbon nanotubes 120 are shaped according to the present invention, the carbon nanotube structure 100 having the carbon nanotubes 120 arranged to a predetermined height and with a smooth upper surface can be obtained.

As described above, according to the present invention, a carbon nanotube structure can be shaped by a relatively simple process. The carbon nanotube structure has high purity since the process leaves no room for contamination by impurities. Furthermore, the conductivity of the carbon nanotube structure can be improved, since a metal layer is included in the carbon nanotube structure.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A carbon nanotube structure comprising:
a substrate;
carbon nanotubes formed on the substrate and shaped in a predetermined shape; and
a metal layer formed on surfaces of the carbon nanotubes to maintain the carbon nanotubes in the predetermined shape.

2. The carbon nanotube structure of claim 1, wherein the metal layer is formed of metal selected from the group consisting of Au, Ag, indium (In), and an alloy of Au—Sn.

3. A method of forming a carbon nanotube structure, comprising:
growing carbon nanotubes on a substrate;
forming a metal layer on surfaces of the carbon nanotubes;
locating a hot pressing apparatus having a mold including a predetermined pattern above upper surfaces of the carbon nanotubes on which the metal layer is formed; and
inserting the carbon nanotubes on which the metal layer is formed into the mold of the hot pressing apparatus, and heating and pressing the carbon nanotubes using the hot pressing apparatus.

4. The method of claim 3, wherein the hot pressing apparatus heats the carbon nanotubes to above the melting point of the metal that constitutes the metal layer.

5. The method of claim 3, wherein the metal layer is formed of metal selected from the group consisting of Au, Ag, indium (In), and an alloy of Au—Sn.

6. The method of claim 3, wherein the metal layer is formed by depositing metal on the surfaces of the carbon nanotubes by sputtering or electron beam evaporation.

7. The method of claim 3, wherein the carbon nanotubes are grown by a chemical vapor deposition.

8. The method of claim 7, wherein the chemical vapor deposition is thermal chemical vapor deposition or plasma enhanced chemical vapor deposition.

9. The carbon nanotube structure formed by the method of claim 3.

10. A method of shaping a carbon nanotube structure, comprising:
preparing carbon nanotubes on a substrate;
forming a metal layer on surfaces of the carbon nanotubes; and
shaping the carbon nanotubes by changing a shape of the metal layer formed on the carbon nanotubes into a predetermined shape.

11. The method of claim 10, wherein the shaping of the carbon nanotubes comprises melting and pressing the metal layer.

12. The method of claim 10, wherein the melting and pressing comprises:
inserting the metal layer formed on the carbon nanotubes into a hollow of a mold, the hollow having a shape corresponding to the predetermined shape;
changing the shape of the metal layer formed on the carbon nanotubes into the predetermined shape by using the mold; and
removing the mold from the metal layer formed on the carbon nanotubes.

13. The method of claim 11, wherein the melting and pressing comprises:
positioning a hot pressing apparatus above upper surfaces of the carbon nanotubes on which the metal layer is formed, the hot pressing apparatus including a mold having a hollow corresponding to the predetermined shape;
inserting the metal layer formed on the carbon nanotubes into the hollow; and
melting and pressing the metal layer formed on the carbon nanotubes using the hot pressing apparatus.

14. The method of claim 13, wherein the melting and pressing further comprises solidifying the metal layer formed on the carbon nanotubes by cooling the metal layer, and removing the hot pressing apparatus from the solidified metal layer formed on the carbon nanotubes.

15. The method of claim 13, wherein the hot pressing apparatus heats the metal layer to above the melting point of the metal that constitutes the metal layer.

16. The method of claim 10, wherein the metal layer is formed of metal selected from the group consisting of Au, Ag, indium (In), and an alloy of Au—Sn.

17. The method of claim 10, wherein the metal layer is formed by depositing metal on the surfaces of the carbon nanotubes by sputtering or electron beam evaporation.

18. The method of claim 10, wherein the preparation of the carbon nanotubes comprises growing the carbon nanotubes by a chemical vapor deposition.

19. The method of claim 13, wherein the hollow has a uniform depth so that the carbon nanotubes with a uniform height are formed.

20. The carbon nanotube structure formed by the method of claim 10.
